(19) United States
(12) Patent Application Publication
(10) Pub. No.: US 2012/0128966 A1
(43) Pub. Date: May 24, 2012

(54) NON-HALOGENATED POLYISOBUTYLENE-THERMOPLASTIC ELASTOMER BLEND PRESSURE SENSITIVE ADHESIVES

(76) Inventors: Jingjing Ma, Cottage Grove, MN (US); Vivek Bharti, Cottage Grove, MN (US); Greg A. Patnode, Woodbury, MN (US); Jayshree Seth, Woodbury, MN (US)

(21) Appl. No.: 13/388,101

(22) PCT Filed: Aug. 3, 2010
(86) PCT No.: PCT/US10/44211

§ 371 Date: Jan. 31, 2012

Related U.S. Application Data
(60) Provisional application No. 61/231,174, filed on Aug. 4, 2009.

(51) Int. Cl. B32B 7/12; C09J 183/04; C09J 123/22; C09J 133/08; C09J 147/00; C09J 153/02

(52) U.S. Cl. 428/317.3; 524/525; 524/505; 524/528; 524/522; 524/506; 428/355 EN; 428/354

(57) ABSTRACT

Multi-phase blended pressure sensitive adhesives are described. The adhesives include a first phase containing at least one non-halogenated polyisobutylene material and a second phase comprising a thermoplastic elastomer. Exemplary thermoplastic elastomers include polyolefins, styrenic block copolymers, acrylic polymers and silicone polymers. Crosslinked adhesives, including those crosslinked with actinic radiation are also described. Adhesive articles including such adhesives are disclosed as well

### FIELD

The present disclosure relates to adhesives containing a blend of non-halogenated polyisobutylene and an elastomer. The present disclosure also relates to adhesive articles such as tapes that include such blended adhesives.

### BACKGROUND

Pressure sensitive adhesives (PSAs) are an important class of materials. As is well known to those of ordinary skill in the art, PSA compositions possess the following properties: (1) aggressive and permanent tack, (2) adherence with no more than finger pressure, (3) sufficient ability to hold on to an adherend, and (4) sufficient cohesive strength to be cleanly removable from the adherend. Generally, PSAs have aggressive and permanent tack, and adhere to a substrate with light pressure, e.g., no more than finger pressure. Although, in some cases, the adhesive force of the PSA to the adherend may exceed the cohesive strength of the PSA resulting in adhesive-split, PSAs often possess sufficient cohesive strength to be cleanly removable from the adherend. In addition, PSAs typically do not require any post-curing (e.g., heat or radiation curing following application of the PSA to the adherend) to achieve their maximum bond strength. A wide variety of PSA chemistries are available including, e.g., acrylic, rubber, and silicone based systems.

In recent years, there has been a significant increase in the use of plastics, vulcanized rubbers, and thermoplastic vulcanizates (“TPV”) in the automotive, appliance and electronics markets. Generally, these materials combine the desirable characteristics of vulcanized rubber with the processing ease of thermoplastics. However, bonding to these and other low surface energy substrates currently requires priming the substrate surface prior to bonding with a pressure sensitive adhesive (“PSA”). The priming process can be expensive and labor intensive, and may present environmental concerns.

Polyisobutylene (“PIB”) has been used in a variety of applications including as a component of in solvent-based adhesives.

### SUMMARY

Briefly, in one aspect, the present disclosure provides a pressure sensitive adhesive comprising a first phase and a second phase. The first phase comprises a non-halogenated polyisobutylene. The second phase comprises a thermoplastic elastomer. In some embodiments, the thermoplastic elastomer comprises one or more of an olefinic polymer, a styrenic block copolymer, an acrylic polymer, and a silicone polymer. In some embodiments, the olefinic polymer is a non-polar olefinic polymer. In some embodiments, the olefinic polymer comprises an olefinic block copolymer.

In some embodiments, the first phase comprises a blend of a first non-halogenated polyisobutylene material having a weight average molecular weight of greater than 100,000 grams per mole, and a second non-halogenated polyisobutylene material having a weight average molecular weight of at least 10,000 grams per mole and no greater than 100,000 grams per mole, wherein the ratio of the weight average molecular weight of the first non-halogenated polyisobutylene material to the weight average molecular weight of the second non-halogenated polyisobutylene material is at least 2:1, and the ratio of the weight percent of the first non-halogenated polyisobutylene material to the weight percent of the second non-halogenated polyisobutylene material in the pressure sensitive adhesive is at least 1:1.

In some embodiments, the first phase further comprises a third polyisobutylene material. In some embodiments, at least one of the polyisobutylene materials is a homopolymer of isobutylene. In some embodiments, the first phase further comprises at least one of a multi-functional acrylate crosslinker and a tackifier.

In some embodiments, the first phase and the second phase are co-continuous. In other embodiments, the first phase is continuous and the second phase is discontinuous and dispersed in the first phase.

In some embodiments, the pressure sensitive adhesive is crosslinked by, e.g., actinic radiation.

In another aspect, the present disclosure provides adhesive articles, e.g., single-coated and double-coated tapes, incorporating the adhesives of the present disclosure and a substrate. Exemplary substrates include papers, films and foams, including those comprising, e.g., polymeric materials and metals.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary adhesive article according to some embodiments of the present disclosure.

FIG. 2 is a TEM image of the polyisobutylene material of Comparative Example CE-6.

FIG. 3 is a TEM image of an exemplary pressure sensitive adhesive according some embodiments of the present disclosure corresponding to Example EX-15.

FIG. 4 is a TEM image of an exemplary pressure sensitive adhesive according some embodiments of the present disclosure corresponding to Example EX-15A.

FIG. 5 is a TEM image of an exemplary pressure sensitive adhesive according some embodiments of the present disclosure corresponding to Example EX-16.

### DETAILED DESCRIPTION

The pressure sensitive adhesives of the present disclosure include two phases. The first phase comprises a polyisobutylene material, specifically, a non-halogenated polyisobutylene material. The second phase comprises a thermoplastic elastomer (TPE). Generally, the thermoplastic elastomer and the polyisobutylene material are sufficiently incompatible such that, when blended, they are substantially immiscible. This results in the desirable phase separated system of the present disclosure.

As used herein, the term “polyisobutylene material” refers one or more polyisobutylene homopolymers, one or more polyisobutylene copolymers, or a mixture thereof. The copolymers can be block copolymers or random copolymers.

Halogenated polyisobutylene based adhesives have been used. Typically, halogenated polyisobutylenes are required in order to crosslink such compositions to obtain the necessary mechanical properties (e.g., peel and shear) required of a pressure sensitive adhesive (PSA). However, the use of halogenated materials presents environmental concerns and may contribute to corrosion and other forms of degradation. In addition, these systems are typically peroxide cured, which can be undesirable in some applications.

The present inventors have surprisingly discovered that, if blended with an incompatible thermoplastic elastomer, non-halogenated polyisobutylenes can be used to form PSAs with acceptable mechanical properties. These properties can be further enhanced with crosslinking, which does not rely on the presence of halogenated groups or peroxide curing, e.g., crosslinking can be achieved with actinic radiation (e.g., UV light or electron beam irradiation).

In some embodiments, the polyisobutylene material is a homopolymer of isobutylene. In some embodiments, the polyisobutylene material may be a copolymer comprising isobutylene repeat units. Typically, at least 70 weight percent, at least 75 weight percent, at least 80 weight percent, at least 85 weight percent, or at least 90 weight percent of the polyisobutylene copolymer is formed from isobutylene repeat units. Exemplary copolymers include isobutylene copolymerized with isoprene.

Low molecular weight polyisobutylene materials have been used as plasticizers with a variety of elastomeric materials, including styrenic block copolymer thermoplastic elastomers. Generally, such polyisobutylene materials have weight average molecular weight of no greater than 10,000 gm/mole, e.g., not greater than 5,000 gm/mole, or even no greater than 2,000 gm/mole. Such low molecular weight materials are compatible with at least one phase of the thermoplastic elastomer and therefore, do not phase separate to form the two-phase systems of the present disclosure.

Exemplary low molecular weight polyisobutylene homopolymers are commercially available under the trade designation GLISSOPAL (e.g., GLISSOPAL 1000, 1300, and 2300) from BASF Corp. (Florham Park, N.J.). These polyisobutylene materials usually have terminal double bonds and are considered to be reactive polyisobutylene materials. These polymers often have a number average molecular weight in the range of about 500 to about 2,300 grams/mole. The ratio of the weight average molecular weight to the number average molecular weight is typically in the range of about 1.6 to 2.0.

In some embodiments of the present disclosure, the polyisobutylene phase comprises at least one high molecular weight polyisobutylene material, i.e., a polyisobutylene material having a weight average molecular weight of greater than 100,000 grams per mole, e.g., at least 200,000 grams per mole, at least 300,000 grams per mole, or even at least 400,000 grams per mole.

In some embodiments, the polyisobutylene phase may contain an intermediate molecular weight polyisobutylene material, i.e., a polyisobutylene material having a weight average molecular weight of greater than 10,000 and no greater than 100,000 gm/mole. In some embodiments, the weight average molecular weight of the intermediate molecular weight polyisobutylene material is no greater than 80,000 gm/mole. In some embodiments, the weight average molecular weight of the intermediate molecular weight polyisobutylene material is at least 30,000 gm/mole, e.g., at least 50,000 gm/mole.

As used herein, all weight-average molecular weights are a weight-average molecular weight based on gel permeation chromatography, unless otherwise indicated.

The polyisobutylene material can include polymeric material having a single molecular weight range or can include a blend of several polymeric materials with each having a different molecular weight range. In some embodiments, blends of at least one intermediate molecular weight polyisobutylene material and at least one high molecular weight polyisobutylene material may be desirable. Generally, the weight average molecular weights of the intermediate and high weight average molecular weight polyisobutylene materials are selected such that the ratio of the weight average molecular weight of the high weight average molecular weight polyisobutylene material to the weight average molecular weight of the intermediate weight average molecular weight polyisobutylene material is at least 2:1, e.g., at least 3:1, at least 4:1, at least 5:1, or even at least 6:1.

In some embodiments, the amounts of the intermediate and high molecular weight polyisobutylene materials are selected such that the weight ratio of high molecular weight polyisobutylene material to intermediate molecular weight polyisobutylene material in the composition is at least 1:1, in some embodiments, at least 1.2:1, or even at least 2:1. In some embodiments, the weight ratio of high molecular weight polyisobutylene material to low molecular weight polyisobutylene material is no greater than 8:1, in some embodiments, no greater than 6:1, or even no greater than 4:1.

The polyisobutylene material can be a homopolymer, copolymer, or a mixture thereof. Copolymers can be random or block copolymers. Block copolymers can include the polyisobutylene sections in the main backbone, in a side chain, or in both the main backbone and a side chain of the polymeric material. The polyisobutylene material is typically prepared by polymerizing isobutylene alone or by polymerizing isobutylene plus additional ethylenically unsaturated monomers in the presence of a Lewis catalyst such as aluminum chloride or boron trifluoride.

Polyisobutylene materials are commercially available from several manufacturers. Homopolymers are commercially available, for example, under the trade designation OPPANOL (e.g., OPPANOL B10, B15, B30, B50, B100, B150, and B200) from BASF Corp. (Florham Park, N.J.). These polymers often have a weight average molecular weight in the range of about 40,000 to 4,000,000 grams per mole. Still other exemplary homopolymers are commercially available from United Chemical Products (UCP) of St. Petersburg, Russia in a wide range of molecular weights. For example, homopolymers commercially available from UCP under the trade designation SDG have a viscosity average molecular weight in the range of about 35,000 to 65,000 grams per mole. Homopolymers commercially available from UCP under the trade designation EFROLEN have a viscosity average molecular weight in the range of about 480,000 to about 4,000,000 grams per mole. Homopolymers commercially available from UCP under the trade designation JHY have a viscosity average molecular weight in the range of about 3000 to about 55,000 grams per mole. These homopolymers typically do not have reactive double bonds.

Polyisobutylene copolymers are often prepared by polymerizing isobutylene in the presence of a small amount of another monomer such as, for example, styrene, isoprene, butene, or butadiene. These copolymers are typically prepared from a monomer mixture that includes at least 70 weight percent, at least 75 weight percent, at least 80 weight percent, at least 85 weight percent, at least 90 weight percent, or at least 95 weight percent isobutylene based on the weight of monomers in the monomer mixture. Suitable isobutylene/isoprene copolymers are commercially available under the trade designation EXXON BUTYL (e.g., EXXON BUTYL 065, 068, 268, 269, and 365) from Exxon Mobil Corp. Other exemplary isobutylene/isoprene copolymers are commercially available from United Chemical Products (St. Petersburg, Russia) such as BK-1675N. Still other exemplary isobutylene/isoprene copolymers are commercially available from LANXESS (Sarnia, Ontario, Canada) such as LANXESS BUTYL 301, LANXESS BUTYL 101-3, and LANXESS BUTYL 402. Suitable isobutylene/styrene block copolymers are commercially available under the trade designation SIBSTAR from Kaneka (Osaka, Japan). These materials are available as both diblocks and triblocks with the styrene content varying from about 15 to 30 weight percent based on the weight of the copolymer.

Generally, the polyisobutylene containing phase of the adhesive of the present disclosure may include one or more additives typical of a pressure sensitive adhesive including one or more of a tackifier, an initiator, an ultraviolet light absorbing agent, and an antioxidant.

Exemplary tackifiers include hydrocarbon resins and hydrogenated hydrocarbon resins, e.g., hydrogenated cycloaliphatic resins, hydrogenated aromatic resins, or combinations thereof. Suitable tackifiers are commercially available and include, e.g., those available under the trade designation ARKON (e.g., ARKON P or ARKON M) from Arakawa Chemical Industries Co., Ltd. (Osaka, Japan); those available under the trade designation ESCOREZ (e.g., ESCOREZ 1315, 1310LC, 1304, 5300, 5320, 5340, 5380, 5400, 5415, 5600, 5615, 5637, and 5690) from Exxon Mobil Corporation, Houston, Tex.; and those available under the trade designation REGALREZ (e.g., REGALREZ 1085, 1094, 1126, 1139, 3102, and 6108) from Eastman Chemical, Kingsport, Tenn.

The initiator can be a thermal initiator or a photoinitiator. The thermal initiator is often a peroxide, hydroperoxides, or azo compound.

In some embodiments, it may be preferable to cure the system using actinic radiation, e.g., ultraviolet (UV) light or electron beam. Examples of photoinitiators suitable in the ultraviolet region include, but are not limited to, benzoin, benzoin alkyl ethers, phenones (e.g., substituted acetophenones), phosphine oxides, polymeric photoinitiators, and the like. Commercially available photoinitiators include, but are not limited to those available from Ciba Specialty chemicals under the trade designations DAROCUR and IRGACURE, e.g., 2-hydroxy-2-methyl-1-phenyl-propane-1-one (e.g., (DAROCUR 1173); 2,4,6-trimethylbenzoyl-diphenyl-phosphine oxide (DAROCUR TPO); a mixture of 2,4,6-trimethylbenzoyl-diphenyl-phosphine oxide and 2-hydroxy-2-methyl-1-phenyl-propan-1-one (DAROCUR 4265); 1-[4-(2-Hydroxyethoxy)-phenyl]-2-hydroxy-2-methyl-1-propane-1-one (IRGACURE 2959); 2,2-dimethoxy-1,2-diphenylethan-1-one (IRGACURE 651); a mixture of bis(2,6-dimethoxybenzoyl)-2,4,4-trimethyl-pentylphosphine oxide and 1-hydroxy-cyclohexyl-phenyl-ketone (IRGACURE 1800); a mixture of bis(2,6-dimethoxybenzoyl)-2,4,4-trimethyl-pentylphosphine oxide (IRGACURE 1700); 2-methyl-1 [4-(methylthio)phenyl]-2-morpholinopropan-1-one (IRGACURE 907); 1-hydroxy-cyclohexyl-phenyl-ketone (IRGACURE 184); 2-benzyl-2-(dimethylamino)-1-[4-(4-morpholinyl)phenyl]-1-butanone (IRGACURE 369); and bis(2,4,6-trimethylbenzoyl)-phenylphosphine oxide (IRGACURE 819).

Other commercially available photoinitiators include ethyl 2,4,6-trimethylbenzoyldiphenyl phosphinate (e.g., commercially available from BASF, Charlotte, N.C. under the trade designation LUCIRIN TPO-L), and 2,4,6-trimethylbenzoyldiphenylphosphine oxide (e.g., commercially available from BASF, Charlotte, N.C. under the trade designation LUCIRIN TPO), and oligo[2-hydroxy-2-methyl-1-[4-(1-methylvinyl)phenyl]propanone] commercially available under the trade designation ESACURE ONE from Lamberti S.P.A. Chemical Specialties (Italy).

Other optional additives can include, for example, ultraviolet absorbents (e.g., benzotriazole, oxazolic acid amide, benzophenone, or derivatives thereof), ultraviolet stabilizers (e.g., hindered amines or derivatives thereof, imidazole or derivatives thereof, phosphorous-based stabilizers, and sulfur ester-based stabilizers), antioxidants (e.g., hindered phenol compounds, phosphoric esters, or derivatives thereof). Exemplary antioxidants include those available from Ciba Specialty Chemicals Incorporated, Tarrytown, N.Y.

In some embodiments, the polyisobutylene phase may also include a crosslinker, e.g., a multifunctional material. The multifunctional materials typically have multiple (meth)acryloyl groups (i.e., groups of formula H₂C═C(R¹)—(CO)— where R¹ is hydrogen or methyl). The multifunctional materials can be a multifunctional (meth)acrylate, multifunctional (meth)acrylamide, or a compound that is both a (meth)acrylamide and (meth)acrylate. Suitable multifunctional materials are those that result in the formation of a crosslinked material that is compatible with the polyisobutylene material and the tackifying resin.

The multifunctional material is often a multifunctional (meth)acrylate. The multifunctional (meth)acrylate usually has two, three, or four (meth)acryloyl groups. The multifunctional material can be of any suitable molecular weight and can include, for example, monomeric, polymeric or oligomeric materials. In some embodiments, the multifunctional (meth)acrylate can be of formula

H₂C═C(R¹)—(CO)—O—R²—O—(CO)—(R¹)C═CH₂

with two (meth)acryloyl groups. In this formula, R¹ is hydrogen or methyl and R² is an alkyene, arylene, heteroalkylene, or a combination thereof.

Any alkylene or heteroalkylene included in R² can be linear, branched, cyclic, or a combination thereof. The heteroalkylene can include any suitable heteroatom but the heteroatom is often oxygen. In many embodiments, the multifunctional (meth)acrylate is an alkylene di(meth)acrylate with an alkylene group having at least 4 to 40 carbon atoms, 8 to 40 carbon atoms, 4 to 30 carbon atoms, 8 to 30 carbon atoms, 4 to 20 carbon atoms, 8 to 20 carbon atoms, 6 to 18 carbon atoms, 8 to 18 carbon atoms, 6 to 16 carbon atoms, 8 to 16 carbon atoms, 8 to 14 carbon atoms, or 8 to 12 carbon atoms. Exemplary alkylene di(meth)acrylates include, but are not limited to, tricylcodecane dimethanol di(meth)acrylate, 1,9-nonanediol di(meth)acrylate, 1,10-decanediol di(meth)acrylate, tricyclodecane dimethanol di(meth)acrylate, tricyclodecanediol di(meth)acrylate, cyclohexane dimethanol di(meth)acrylate, 1,6-hexanediol di(meth)acrylate, or hydrogenated polybutadiene di(meth)acrylate.

Exemplary heteroalkylene di(meth)acrylates include, but are not limited to, polyethylene glycol di(meth)acrylate such as those commercially available from Sartomer (Exton, Pa.) under the trade designation SR210 (based on a polyethylene glycol with a weight average molecular weight of about 200 grams/mole), SR252 (based on a polyethylene glycol with a weight average molecular weight of about 400 grams/mole), and SR603 (based on a polyethylene glycol with a weight average molecular weight of about 600 grams/mole).

Suitable multifunctional (meth)acrylates with three (meth)acryloyl groups include, but are not limited to, trimethylolpropane tri(meth)acrylate. Suitable oligomeric materials include, but are not limited to, urethane acrylate oligomers.

In addition to the polyisobutylene-containing phase, the PSAs of the present disclosure include a second phase comprising a thermoplastic elastomer. The term “thermoplastic elastomer” is well-known in the art. Generally, a thermoplastic elastomer (“TPE”), sometimes referred to as a thermoplastic rubber, is material exhibiting both elastomeric and thermoplastic properties.

Typically, a TPE comprises both a hard (e.g., crystalline or high glass transition temperature (Tg)) portion and a soft (e.g., low Tg) portion. The hard portion contributes to the thermoplastic behavior, as at elevated temperatures the hard portions soften and, with the soft portion, provides a melt-flowable mixture that can be processed in typical hot melt coating applications (e.g., extrusion). The soft segment, which remains flexible even at lower temperature, e.g., room temperature, provides the elastomeric properties of the TPE.

Exemplary TPEs include block copolymers (e.g., random block copolymers) and graft copolymers wherein the hard and soft portions are combined in a single copolymer. In some embodiments, TPEs comprise a blend of hard and soft components. In still other embodiments, low molecular weight additives, e.g., plasticizers, may be used to lower the Tg and “soften” some blocks of a block copolymer resulting in the hard and soft segments typical of a TPE.

In some embodiments, the thermoplastic elastomer comprises an olefinic polymer. In some embodiments, non-polar, olefinic, thermoplastic elastomers may be desirable. In some embodiments, the non-polar olefinic TPE is an olefinic copolymer. Exemplary copolymers include copolymers of ethylene and an alpha-olefin, e.g., 1-butene and 1-octene. Commercially available olefinic copolymers include those available under the trade designation ENGAGE (e.g., ENGAGE 8400, 8401, 8402, 8407, and 8411) from Dow Chemical Co. In some embodiments, the olefinic copolymer is an olefinic block copolymers such as ethylene alpha-olefin block copolymers. Exemplary alpha olefins include e.g., 1-octene. Commercially available olefinic block copolymers include those available under the trade designation INFUSE (e.g., INFUSE D9000.05, D9100.05, D9007.15, D9107.15, D9500.05, D9507.15, DP9530.05, D9807.15, and D9817.15) from Dow Chemical Company.

Other non-polar, olefinic, TPEs include ethylene-propylene random copolymers (EPM), and ethylene-propylene-diene terpolymers (EPDM). Commercially available EPMs include those available under the trade designation VISTALON (e.g., VISTALON 404, 403, 706, 722, 785, and 805) from ExxonMobil Chemical Co. Commercially available EPDMs include those available under the trade designation VISTALON (e.g., VISTALON 1703P, 2504, 2504N, 2605B, 3666, 3666B, 3702, 3708, 5601, 7001, 7500, 7800P, 8731, 6505, 8600, 8700, 8800, and 9500) from ExxonMobil Chemical Co.

In some embodiments, polar olefinic TPEs may be acceptable. Exemplary polar olefinic TPEs include ethylene vinyl acetate (EVA), ethylene vinyl acetate polymers (e.g., BYNEL 1123, 1124, 30E670, 30E671, 30E753, 30E783, 3101, 3126, 3810, 3860, 3861, E418, 3930, and 39E660 from E.I. du Pont de Nemours and Company), ethylene acrylate resins (e.g., BYNEL 2002, 2022, 21E533, 21E781, 21E810, 21E830, 22E757, 22E780, and 22E804 from E.I. du Pont de Nemours and Company).

In some embodiments, the thermoplastic elastomer may be a styrenic block copolymer, i.e., a block copolymer comprising at least one styrene hard segment, and at least one elastomeric soft segment. Exemplary styrenic block copolymers include styrene-isoprene-styrene (SIS), styrene-butadiene-styrene (SBS), styrene-ethylene/butadiene-styrene (SEBS), and styrene-ethylene/propylene-styrene block copolymers. Commercially available styrenic block copolymers include those available under the trade designation KRATON from Kraton Polymers LLC. including, e.g., KRATON D SBS and SIS block copolymers; and KRATON G SEBS and SEPS copolymers. Additional commercially available di- and tri-block styrenic block copolymers include those available under the trade designations SEPTON and HYBAR from Kuraray Co. Ltd., and those available under the trade designation VECTOR from Dexco Polymers LP.

In some embodiments, the thermoplastic elastomer may be an acrylic polymer. In some embodiments, the acrylic polymer comprises the reaction product of at least one acrylic or methacrylic ester of a non-tertiary alkyl alcohol and, optionally, at least one copolymerized reinforcing monomer. In some embodiments, the acrylic adhesive composition comprises at least about 70 parts, in some embodiments, at least about 80 parts, at least about 90 parts, at least about 95 parts, or even about 100 parts of at least one acrylic or methacrylic ester of a non-tertiary alkyl alcohol. In some embodiments, acrylic adhesive composition comprises no greater than about 30 parts, in some embodiments, no greater than about 20 parts, no greater than about 10 parts, no greater than about 5 parts, and even no greater than 1 part of at least one copolymerized reinforcing monomer. In some embodiments, the acrylic adhesive composition does not include a copolymerized reinforcing monomer.

In some embodiments, the non-tertiary alkyl alcohol contains 4 to 20 carbon atoms, e.g., 4 to 8 carbon atoms. Exemplary acrylic acid esters include isooctyl acrylate, 2-ethylhexyl acrylate, butyl acrylate, isobornyl acrylate, and combinations thereof. Exemplary methacrylic acid esters include the methacrylate analogues of these acrylic acid esters. In some embodiments, the copolymerized reinforcing monomer is selected from the group consisting of acrylic acid, methacrylic acid, 2-carboxyethyl acrylate, N,N′ dimethyl acrylamide, N,N′ diethyl acrylamide, butyl carbamoyl ethyl acrylate, and combinations thereof.

In some embodiments, the thermoplastic elastomer may be a silicone polymer, e.g., a silicon pressure sensitive adhesive. Generally, silicone pressure sensitive adhesives have been formed by a condensation reaction between a polymer or gum and a tackifying resin. The polymer or gum is typically a high molecular weight silanol-terminated poly(diorganosiloxane) material e.g., silanol-terminated poly(dimethylsiloxane) (“PDMS”) or poly(dimethylmethylphenylsiloxane). The tackifying resin is typically a three-dimensional silicate structure end-capped with trimethylsiloxy groups. In addition to the terminal silanol groups of the polymer or gum, the tackifying resin may also include residual silanol functionality.

Generally, any known tackifying resin may be used, e.g., in some embodiments, silicate tackifying resins may be used. In some exemplary adhesive compositions, a plurality of silicate tackifying resins can be used to achieve desired performance. Suitable silicate tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary silicate resins include MQ silicate tackifying resins, MQD silicate tackifying resins, and MQT silicate tackifying resins. These silicate tackifying resins usually have a number average molecular weight in the range of 100 to 50,000-gm/mole, e.g., 500 to 15,000 gm/mole and generally R′ groups are methyl groups.

Exemplary, commercially available silicone PSAs containing both a silicone polymer and tackifying resin include those available from Dow Corning including, e.g., 7355, 7358, 7657, Q2-7406, Q2-7566 and Q2-7735. Commercially available silicone PSAs also include those available from Momentive Performance Materials, Inc. including PSA529, PSA590, PSA595, PSA610, PSA6537A, PSA750, PSA910, PSA915, PSA518, PSA6574, PSA6574-200, and PSA6574A.

In some embodiments, the adhesives of the present disclosure may be crosslinked to improve their mechanical properties. Surprisingly, in some embodiments, the adhesives of the present disclosure can be crosslinked even in the absence of halogen groups on the polyisobutylene material. In some embodiments, the adhesive can be crosslinked with actinic radiation. In some embodiments, the adhesives can be crosslinked with ultraviolet (UV) light. In some embodiments, the adhesives can be crosslinked with electron beam irradiation.

The adhesives of the present disclosure may be used in any of a wide variety of applications in which pressure sensitive adhesives may be used. In particular, in some embodiments, adhesives of the present disclosure may be suitable for binding to low surface energy substrates such as EPDM and silicone rubber.

The adhesives of the present disclosure may be combined with a substrate to form any number of typical adhesive articles, e.g., single- and double-coated tapes, and laminating adhesives. Generally, laminating adhesives may comprise either a free film of adhesive or an adhesive film embedded with a support, e.g., a woven or non-woven scrim. Such products can be formed by applying (e.g., coating, casting, or extruding) the adhesive onto a release liner, and drying and/or curing the adhesive.

The adhesives of the present disclosure may also be applied to one or both sides of a substrate to form a single- or double-coated tape. Any known substrate, including single and multi-layer substrates comprising one or more of paper, polymeric film, and metal (e.g., metal foil) may be used. In some embodiments, one or more layers of the substrate may be foam. In some embodiments, one or both adhesive layers may be bonded directly to the substrate. In some embodiments, one or both adhesive layers may be indirectly bonded to the substrate. For example, in some embodiments, one or more intermediate layers (e.g., primer layers) may be interposed between the substrate and the adhesive layer.

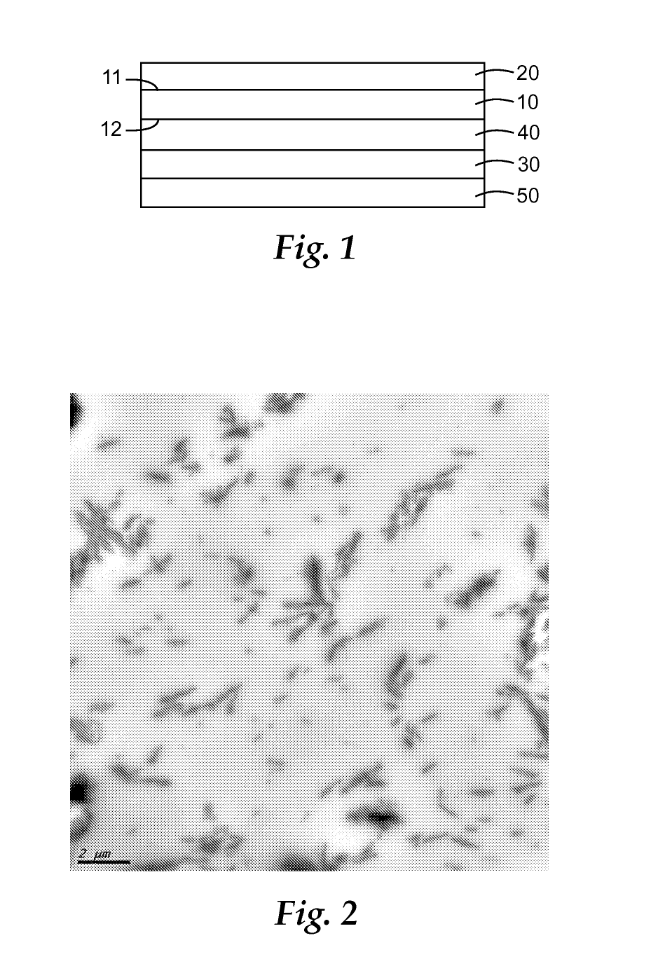

One exemplary adhesive article according to some embodiments of the present disclosure is shown in FIG. 1. Adhesive article 100 comprises substrate 10 and first adhesive layer 20 directly bonded to first surface 11 of substrate 10. Adhesive article 100 also includes second adhesive layer 30 (which may be selected independently of the adhesive of the first adhesive layer) indirectly bonded to second surface 12 of substrate 10, via interposed primer layer 40. Optional release liner 50 is bonded to the surface of second adhesive layer 30, opposite substrate 10. In some embodiments, adhesive article 100 may be self-wound such that first adhesive layer 20 contacts the side of release liner 50 opposite second adhesive layer 30. In some embodiments, a second release liner (not shown) may be applied to first adhesive layer 20, opposite substrate 10.

Examples. The following, non-limiting, examples further describe exemplary adhesives and adhesive articles of the present disclosure, as well as exemplary methods for making such adhesives and adhesive articles. All percents are by weight unless otherwise indicated.

The materials used in the following examples are summarized in the tables below. Various non-halogenated polyisobutylene materials are provided in Table 1A.

Various elastomers are listed in Table 1B. Additives used in the preparation of the examples are described in Table 1C. Various films and substrates are listed in Table 1D. Finally, several commercially available tapes are listed in Table 2.

TABLE 1A
Non-halogenated polyisobutylene materials

| Material | ID | Description | Manufacturer |
|---|---|---|---|
| BUTYL 268 | B268 | A copolymer of isobutylene and | Exxon Mobil |
| | | isoprene having an unsaturation of | Corporation, |
| | | 1.70 mol % and a Mooney viscosity of | Houston, TX |
| | | 51 (ML 1 + 8 (125° C.)), and believed to | |
| | | have a molecular weight of 450,000 | |
| | | gram/mole, commercially available | |
| | | under the trade designation EXXON | |
| | | BUTYL 268. | |
| OPPANOL | B15 | Polyisobutylene elastomer having a | BASF |
| B15 | | weight average molecular weight | Corporation, |
| | | (Mw) of about 75,000 grams/mole. | Florham Park, NJ |
| GLISSOPAL | G1000 | Polyisobutylene viscous, oily liquid | BASF |
| G1000 | | having a number average molecular | Corporation, |
| | | weight (Mn) of about 1,000 | Florham Park, NJ |
| | | grams/mole and a molar mass | |
| | | distribution Mw/Mn = 1.6. | |

TABLE 1B
Elastomers

| Material | ID | Description | Manufacturer |
|---|---|---|---|
| KRATON | KG1651 | Hydrogenated styrene-butadiene | Kraton Polymers |
| G1651 | | copolymer having a styrene content of | U.S. LLC, |
| | | 33% by weight. | Houston, TX |
| KRATON | KG1657 | Hydrogenated styrene-butadiene | Kraton Polymers |
| G1657 | | copolymer having a styrene content of | U.S. LLC, |
| | | 13% by weight. | Houston, TX |
| KRATON | KD1340 | Styrene/isoprene block copolymer | Kraton Polymers |
| D1340 | | having a styrene content of 9% by | U.S. LLC, |
| | | weight as described for Polymer B in | Houston, TX |
| | | Table 2 of U.S. Pat. No. 5,296,547 | |
| | | (Nestegard et al.) | |
| ENGAGE | ENGAGE | An ultra low density copolymer of | The Dow |
| 8842 | | ethylene/octene with a melt index of 1 | Chemical |
| | | (190° C., 2.16 kg), g/10 min. per ASTM | Company, |
| | | D 1238) | Midland, MI |
| INFUSE | INFUSE | A polyolefin block copolymer having | The Dow |
| D9807.15 | | alternating blocks of hard (highly | Chemical |
| | | rigid) and soft (highly elastomeric) | Company, |
| | | segments with a melt index of 15 | Midland, MI |
| | | (190° C., 2.16 kg), g/10 min. per ASTM | |
| | | D 1238) | |

TABLE 1C
Additives

| Material | ID | Description | Manufacturer |
|---|---|---|---|
| ESCOREZ | ES1310 | A hydrocarbon tackifier resin, having | Exxon Mobil |
| 1310 LC | | a weight average molecular weight of | Corporation, |
| | | about 1350 grams/mole, a softening | Houston, TX |
| | | point of 95° C., and a glass transition | |
| | | temperature of about 45° C. | |
| REGALREZ | R1085 | Hydrocarbon tackifier resin, having a | Eastman |
| | | weight average molecular weight of | Chemical, |
| | | 1000 grams/mole. | Kingsport, TN |
| SR351H | TMPTA | Trimethylpropane-triacrylate; a low | Sartomer, Exton, |
| | | viscosity, trifunctional acrylate monomer | PA, USA |
| | | having a molecular weight of 296. | |
| Triazine | TZ | 2,4-bis(trichloromethyl)-6-(4- | 3M Company, St. |
| | | methoxyphenyl)-sym-triazine, used as | Paul, MN |
| | | a crosslinking agent. | |
| DAROCUR | TPO | 2,4,6-trimethylbenzoyl-diphenyl- | Ciba Specialty |
| TPO | | phosphine oxide; melting point of 88- | Chemicals |
| | | 92° C.; used as a photoinitiator. | Incorporated, |
| | | | Tarrytown, NY |
| IRGACURE | I-2959 | 1-[4-(2-Hydroxyethoxy)-phenyl]-2- | Ciba Specialty |
| 2959 | | hydroxy-2-methyl-1-propane-1-one; | Chemicals |
| | | used as a photoinitiator. | Incorporated, |
| | | | Tarrytown, NY |
| IRGANOX | I-1076 | Octadecyl-3-(3,5-di-t-butyl-4- | Ciba Specialty |
| 1076 | | hydroxyphenyl)-propionate; a | Chemicals |
| | | sterically hindered phenolic | Incorporated, |
| | | antioxidant having a melting point of | Tarrytown, NY |
| | | 50-55° C. | |

TABLE 1D
Films and substrates.

| Material | Description | Source |
|---|---|---|
| EPDM | Ethylene propylene diene class M rubber; | Zatkoff Seals & |
| | having a durometer hardness of 60, measuring | Packings, Warren, |
| | 5.1 × 12.7 × 0.15 cm (2 × 5 × 0.059 in.); | MI |
| | available as EPDM, Part No. RZW07-015 | |
| SANTOPRENE | Natural Santoprene 201-55, a thermoplastic | Zatkoff Seals & |
| | vulcanizate of ethylene propylene diene class M | Packings, Warren, |
| | rubber (EPDM) and polypropylene; measuring | MI |
| | 5.1 × 12.7 × 0.21 cm (2 × 5 × 0.084 in.); | |
| | available as Part No. RZW07-016, | |
| Stainless Steel | SS, 304, 18 gauge stainless steel, bright | ChemInstruments, |
| | annealed finish. | Incorported, |
| | | Fairfield, OH |
| Silicone Rubber | Orange-red silicone rubber panel having a | McMaster Carr, |
| | thickness of 1.6 mm ( 1/16 inch) and a | Chicago, IL. |
| | Durometer hardness of 60A; available as Part | |
| | No. 8632K922. | |
| MITSUBISHI | A chemically treated, clear polyester film | Mitsubishi |
| Polyester | having a thickness of 50 micrometers (0.002 | Polyester Film, |
| Backing Film | inches); available as HOSTAPHAN 3SAB | Incorporated, |
| | Silicone Adherable Film. | Greeer. SC |
| LOPAREX | A fluorosilicone coated release liner, available | Loparex North |
| Release Liner | as REXAM No. 20987. | America |
| | | Incorporated, |
| | | Bedford Park, IL |

TABLE 2
Commercially available tapes.

| Material | ID | Description | Source |
|---|---|---|---|
| 3M ™ | 3M ™ | An adhesive transfer tape having an | 3M Company, St. |
| Adhesive | 6035PC | acrylic pressure sensitive adhesive on | Paul, MN |
| Transfer Tape | | one side of a polycoated Kraft paper | |
| 6035PC | | liner, with an adhesive thickness of | |
| | | 0.13 mm (0.005 inches) and a liner | |
| | | thickness of 0.11 mm (0.0042 inches) | |
| ADCHEM | ADCHEM | A double coated, general purpose tape | Adchem |
| 5000M | 5000M | product having a rubber-based | Corporation, |
| Double | | adhesive and a 0.013 mm (0.0005 | Riverhead, NY |
| Coated Tape | | inch) thick polyester carrier. | |
| ADCHEM | ADCHEM | A double coated tape having a rubber- | Adchem |
| 5944M | 5944M | based adhesive on one side of a 0.013 | Corporation, |
| Double | | mm (0.0005 inch) thick polyester | Riverhead, NY |
| Coated Tape | | carrier and an acrylic adhesive on the | |
| | | opposite side. | |

Test Methods

90° Angle Peel Adhesion Strength Test. Evaluation of peel adhesion strength at an angle of 90° was performed as described in the ASTM International standard, D3330, Method F, with a 1.3 cm×20 cm (½ in.×8 in.) test specimen using an IMASS SP-200 slip/peel tester (available from IMASS, Inc., Accord, Mass.) at a peel rate of 305 mm/minute (12 inches/minute). The samples were adhered to the test panels by rolling down the tapes with a 2.0 kg (4.5 lb.) rubber roller using 4 passes. The test panels included EPDM, SANTOPRENE (“SP”), and silicone rubber (“S-R”). The peel tests were performed after a 24 hour dwell time in a controlled environment room on the test panel, unless otherwise stated. The average peel adhesion force required to remove the tape from the panel was measured in ounces and is expressed in Newtons/decimeter (N/dm), based on 3 samples.

Static Shear Strength at 23° C./50% Relative Humidity Test. Evaluation of static shear strength was performed as described in the ASTM International standard, D3654, Procedure A, with a 1.3 cm×2.5 cm (½ in.×1M.) test specimen and a 1000 g load. The test panels were stainless steel (“SS”). Time to failure in minutes was recorded. If no failure was observed after 10,000 minutes, the test was stopped and a value of 10,000+ minutes was recorded.

All amounts are stated as weight percent unless otherwise indicated.

### Examples 1-10 and Comparative Examples 1-4

Samples were prepared by combining a hydrogenated styrene-butadiene copolymer elastomer (KG1651 or KG1657) with blends of non-halogenated polyisobutylenes (B268, B15, and G1000). The samples also included a tackifier (R-1085). The composition of Comparative Example 1 (CE-1) and Examples 1 to 8 (EX-1 to EX-8) are summarized in Table 3.

TABLE 3
Compositions of Comparative Example 1 and Examples 1 to 8.

| | | Weight percent | | | | | |
|---|---|---|---|---|---|---|---|
| | Elastomer | Elastomer | | | | | |
| Ex. | Additive | Additive | B268 | B15 | G1000 | R-1085 | I-1076 |
| CE-1 | KG1651 | 0.0 | 44.8 | 10.0 | 0.0 | 44.8 | 0.5 |
| EX-1 | KG1651 | 5.2 | 36.6 | 10.5 | 0.0 | 47.1 | 0.5 |
| EX-2 | KG1651 | 10.5 | 31.4 | 10.5 | 0.0 | 47.1 | 0.5 |
| EX-3 | KG1651 | 15.7 | 26.2 | 10.5 | 0.0 | 47.1 | 0.5 |
| EX-4 | KG1651 | 20.9 | 20.9 | 10.5 | 0.0 | 47.1 | 0.5 |
| EX-5 | KG1657 | 5.2 | 36.6 | 0.0 | 10.5 | 47.1 | 0.5 |
| EX-6 | KG1657 | 10.5 | 31.4 | 0.0 | 10.5 | 47.1 | 0.5 |
| EX-7 | KG1657 | 15.7 | 26.2 | 0.0 | 10.5 | 47.1 | 0.5 |
| EX-8 | KG1657 | 20.9 | 20.9 | 0.0 | 10.5 | 47.1 | 0.5 |

Solvent Coating Procedure. For each sample, all ingredients were placed in a glass jar and toluene was added to give a solution of 20% to 40% solids. The jar was capped shut and put on a roller overnight for mixing. The adhesive solution was then coated onto the treated side of the MITSUBISHI PET film backing using a 15.2 cm (6 in.) wide knife coater. The coating gap was set to provide an adhesive having a thickness of 0.051 mm (0.002 inches) or 0.13 mm (0.005 inches) after drying in an oven at 71° C. (160° F.) for 10 to 15 minutes. The adhesive side of the resulting tape article was covered with a release liner and stored in a controlled environment room (23° C. and 50% relative humidity) until tested.

Each sample was tested according to the 90° Angle Peel Adhesion Strength Test using both EPDM and SANTOPRENE as substrates. Each sample was also tested according to the Static Shear Strength at 23° C./50% Relative Humidity Test using stainless steel as the substrate. The results are summarized in Table 4.

TABLE 4
Shear and peel strength for Comparative
Example 1 and Examples 1 to 8.

| | Shear Strength | Peel Strength | Peel Strength |
|---|---|---|---|
| | Stainless steel | EPDM | SANTORENE |
| Example | (min.) | (N/dm) | (N/dm) |
| CE-1 | 46 | 45 | 77 |
| EX-1 | 79 | 49 | 85 |
| EX-2 | 175 | 43 | 60 |
| EX-3 | 1062 | 39 | 56 |
| EX-4 | 6205 | 39 | 28 |
| EX-5 | 23 | 50 | 54 |
| EX-6 | 36 | 52 | 40 |
| EX-7 | 64 | 42 | 44 |
| EX-8 | 2763 | 38 | 30 |

### Examples 9-10 and Comparative Example 2

Samples were prepared by combining a styrene/isoprene block copolymer elastomer (KD1340) with blends of non-halogenated polyisobutylenes (B268 and G1000). The samples also included a tackifier (ES1310). The compositions of Comparative Example 2 and Examples 9 and 10 are summarized in Table 5. Samples were prepared according to the Solvent Coating Procedure. The samples were tested according to the 90° Angle Peel Adhesion Strength (EPDM and SANTOPREN) and the Static Shear Strength at 23° C./50% Relative Humidity Test (stainless steel). The results are summarized in Table 6.

TABLE 5
Compositions of Comparative Example 2 and Examples 9 and 10.

| | | Weight percent | | | | |
|---|---|---|---|---|---|---|
| | Polymer | Polymer | | | | |
| Example | Additive | Additive | B268 | G1000 | ES1310 | I-1076 |
| CE-2 | KD1340 | 0.0 | 39.8 | 14.9 | 44.8 | 0.5 |
| EX-9 | KD1340 | 10.0 | 29.9 | 10.0 | 49.8 | 0.5 |
| EX-10 | KD1340 | 19.9 | 19.9 | 10.0 | 49.8 | 0.5 |

TABLE 6
Shear and peel strength for Comparative
Examples 2-4, and Examples 9 and 10.

| | Shear Strength | Peel Strength | Peel Strength |
|---|---|---|---|
| | stainless steel | EPDM | SANTOPRENE |
| Example | (min.) | (N/dm) | (N/dm) |
| CE-2 | 6 | 63 | 51 |
| EX-9 | 35 | 59 | 35 |
| EX- 10 | 2299 | 43 | 28 |

### Examples 11-16 and Comparative Examples 3-6

Samples were prepared by combining an elastomer with blends of non-halogenated polyisobutylenes (B268 and B 15). The samples also included a tackifier (ES1310), a trifunctional acrylate monomer (TMPTA), and a sterically hindered phenolic antioxidant (1-1076).

The elastomer used for Examples 11 and 16 was an ultra low density copolymer of ethylene/octene (ENGAGE 8842). The elastomer used in Examples 12 and 15 was a polyolefin block copolymer (INFUSE D9807.15). An acrylic polymer, prepared as described below, was used as the elastomer in Examples 13 and 14. Comparative Examples CE-3 to CE-6 included the blend of non-halogenated polyisobutylene materials, but did not include a thermoplastic elastomer additive. The composition of Comparative Examples 3-6 and Examples 11-16 are summarized in Table 7.

TABLE 7
Composition of Comparative Examples
5 to 7 and Examples 11 to 16.

| | Polymer additive | | Weight percent | | | | |
|---|---|---|---|---|---|---|---|
| Ex. | type | Wt. % | B268 | B15 | ES1310 | TMPTA | I-1076 |
| CE-3 | — | — | 59.4 | 9.9 | 29.7 | 0.0 | 1.0 |
| CE-4 | — | — | 49.5 | 9.9 | 39.6 | 0.0 | 1.0 |
| CE-5 | — | — | 39.6 | 9.9 | 49.5 | 0.0 | 1.0 |
| EX-11 | ENGAGE | 9.9 | 39.6 | 9.9 | 39.6 | 0.0 | 1.0 |
| EX-12 | INFUSE | 9.9 | 39.6 | 9.9 | 39.6 | 0.0 | 1.0 |
| EX-13 | Acrylic | 11.9 | 35.6 | 9.9 | 39.6 | 2.0 | 1.0 |
| EX-14 | Acrylic | 6.9 | 40.6 | 9.9 | 39.6 | 2.0 | 1.0 |
| CE-6 | — | — | 52.4 | 28.6 | 14.3 | 3.5 | 1.0 |
| EX-15 | INFUSE | 14.3 | 44.9 | 24.5 | 12.3 | 3.0 | 0.8 |
| EX-16 | ENGAGE | 14.3 | 44.9 | 24.5 | 12.3 | 3.0 | 0.8 |

In addition to the materials listed in Table 7, Example EX-15 further included 0.16 weight percent of a photoinitiator (1-2959). Similarly, Comparative Example CE-6 and Example EX-16 further included 0.16 weight percent of a photoinitiator (TPO).

Preparation of Acrylic Polymer of Examples EX-13 and EX-14.

Two sheets of a heat-sealable0.0635 mm (0.0025 inches) thick ethylene vinyl acetate film having 6% vinyl acetate content (VA24, from Consolidated Thermoplastics Co. of Schaumburg, Ill.) were heat sealed on the lateral edges and the bottom on a liquid form, fill, and seal machine to form a rectangular tube measuring 3.175 cm (1.25 inches) wide. The tube was then filled with a composition comprising 47.75 grams of 2-ethylhexyl acrylate (2-EHA), 47.75 grams of butyl acrylate (BA), and 4.5 grams of acrylic acid (AA). The composition further included 0.20 parts of benzil dimethyl ketal photoinitiator (IRGACURE 651 from Ciba Geigy) per 100 parts of total monomer (“PHR”), 0.02 PHR isothioglycolate (IOTG), 0.4 PHR of IRGANOX 1076, and 0.2 PHR para-acryloxybenzophenone. The filled tube was then heat sealed at the top and at periodic intervals along the length of the tube in the cross direction to form individual pouches measuring 3.175 cm by 3.175 cm by about 0.356 cm thick, each containing 1.9 grams of composition. The pouches were placed in a water bath that was maintained between about 21° C. and 32° C., and exposed to ultraviolet radiation at an intensity of about 2 mW/cm² for 8.33 minutes to cure the composition. The radiation was supplied from lamps having about 90% of the emissions between 300 and 400 nanometers (nm), and a peak emission at 351 nm. The resulting pouch-adhesive was used to prepare tape articles of the invention using a hot melt process.

Compounding Procedure. For Comparative Examples CE-4 to CE-6 and Examples EX-11 to EX-16, the B268 polyisobutylene material was ground to crumb form to facilitate feeding and further compounding. To grind the B268 rubber, bales of the material were first broken into chunks using a RITEZ PREBREAKER, model PB-24-H3L241 available from Hosokawa Micron Ltd., Runcorn, Chesire, U.K. The chunks were then fed into a PALLMAN GRINDER, Model PS 4-5FWG2 available from Pallmann Pulverizers Co., Inc. Clifton, N.J. Talc was added to the grinder using an ACRISON, Model 105Z-C feeder, available from Acrison, Inc., Moonachie, N.J. Talc was added to ease subsequent feeding and to prevent the crumbs from sticking together. The talc added was MISTRON Vapor Densified Talc available from Luzenac American Inc., Grand Island, Nebr. The excess talc was then removed using a KASON, Model K40.1.BT.CS screen separator, available from Kason Corporation, Millburn, N.J.

Extrusion Coating Procedure. These compositions were coated onto the treated side of the MITSUBISHI PET film at a coating speed of 3.05 meters/minute (10 feet/minute) using a co-rotating twin screw extruder (TSE) (Model ZSK 30, available from Werner & Pfleiderer, Ramsey, N.J.) having a 30 mm diameter, a 36 to 1 length to diameter ratio, and 12 barrel sections feeding a 15.2 cm (6 inch) wide rotary rod die. The throughput rate was 4.53 kg/hr. (10 lbs/hr.) and the screw speed was 450 rpm. The barrel zone temperatures were set as shown in the Table 8. The B15 material was fed into the TSE using a 5.08 cm BONNOT extruder (available from the Bonnot Company, Uniontown, Ohio) set at 121° C. (250° F.). Where employed, the acrylic polymer additive was also introduced using a BONNOT extruder. A tape article having an adhesive layer thickness of 0.13 mm (0.005 inches) was obtained. The adhesive side of the resulting tape article was covered with a release liner and stored in a controlled environment room until tested.

TABLE 8
Summary of extruder conditions.

| Zone | Set Temperature | Comments |
|---|---|---|
| 1 | 21° C. (70° F.) | B268, polymer additive (except acrylic polymer), |
| | | ES1310, I-1076 were fed using a weight loss feeder |
| 2 | 82° C. (180° F.) | Nitrogen purge gas |
| 3 | 82° C. (180° F.) | |
| 4 | 260° C. (500° F.) | B15 fed using a BONNOT extruder set at 121° C. (250° F.) |
| 5 | 260° C. (500° F.) | |
| 6 | 260° C. (500° F.) | Acrylic polymer (when used) was fed using a |
| | | BONNOT extruder set at 121° C. (250° F.) |
| 7 | 260° C. (500° F.) | |
| 8 | 260° C. (500° F.) | TMPTA fed using a peristaltic pump |
| 9-12 | 260° C. (500° F.) | |
| Flange | 260° C. (500° F.) | |

Comparative Example CE-6A corresponds to Comparative Example 6, and Examples EX-15A and EX-16A correspond to Examples EX-15 and EX-16, respectively. However, these samples were further treated, after coating, by electron beam irradiation through the MITSUBISHI PET film, in a nitrogen atmosphere, with a dose of 4 MRad at 300 keV using an ELECTOCURTAIN CB-300 electron beam system available from Energy Sciences, Incorporated, Wilmington, Mass.

Comparative Examples CE-3 to CE-5 and Examples EX-11 to EX-14 were tested according to the 90° Angle Peel Adhesion Strength Test (EPDM and SANTOPREN) and the Static Shear Strength at 23° C./50% Relative Humidity Test (stainless steel). The results are summarized in Table 9A.

TABLE 9A
Results for Comparative Examples CE-3
to CE-5 and Examples EX-11 to EX-14.

| | Shear Strength | Peel Strength | Peel Strength |
|---|---|---|---|
| | stainless steel | EPDM | SANTOPRENE |
| Ex. | (min.) | (N/dm) | (N/dm) |
| CE-3 | 28 | 63 | 50 |
| CE-4 | 33 | 58 | 87 |
| CE-5 | 30 | 48 | 66 |
| EX-11 | 54 | 67 | 99 |
| EX-12 | 70 | 68 | 101 |
| EX-13 | 75 | 49 | 92 |
| EX-14 | 72 | 58 | 87 |

Similarly, Comparative Example CE-6 and Examples EX-15 and EX-16 were tested according to the 90° Angle Peel Adhesion Strength Test (EPDM and SANTOPREN) and the Static Shear Strength at 23° C./50% Relative Humidity Test (stainless steel) and the results compared to their corresponding electron beamed samples, i.e., Comparative Example CE-6A and Examples EX-15A and EX-16A, respectively. The results are summarized in Table 9B.

TABLE 9B
Results for Comparative Examples CE-6 and CE-6A,
and Examples EX-15, EX-15A, EX-16, and EX-16A.

| | Shear Strength | Peel Strength | Peel Strength |
|---|---|---|---|
| | stainless steel | EPDM | SANTOPRENE |
| Ex. | (min.) | (N/dm) | (N/dm) |
| CE-6 | 18 | 90 | 35 |
| CE-6A (a) | 78 | 41 | 35 |
| EX-15 | 37 | 85 | 79 |
| EX-15A (a) | 4708 | 56 | 79 |
| EX-16 | 55 | 55 | — (b) |
| EX-16A (a) | 875 | 49 | 39 |

(a) Electron beam dose of 4 Mrads.
(b) Two-bond failure; therefore, the adhesive bond between the SANTORPENE adherend and EX-16 exceeded the bond between EX-16 and the PET backing of the test sample.

### Examples 17-19 and Comparative Examples 7 and 8

Comparative Example 7 (CE-7) was a 25 wt. % solids solution of polyisobutylene adhesive prepared by combining 14.5 wt. % ES1310 tackifier, 2.9 wt. % TMPTA trifunctional acrylate monomer, 0.1 wt. % TZ triazine crosslinker, and 0.5 wt. % of 1-1076 antioxidant with a blend of non-halogenated polyisobutylenes (67.6 wt. % B268 and 14.5 wt. % B15).

CE-8 was a silicone polymer prepared as follows. A peroxide solution was made by adding 3.0 g of peroxide paste (SID 3352.0 from Gelest), 7.2 g of toluene, and 1.8 g of MEK. The paste contained 50% dichlorobenzoyl peroxide and 50% silicone fluid. The resulting peroxide solution was 25% solids with a 80:20 weight ratio of toluene:MEK. 100 g of Q2-7735 silicone polymer (Dow Corning Corporation, Midland, Mich.) (56% solids), 58.6 g of toluene, and 2.24 g of the peroxide solution were combined in a container. This yielded a solution that contained 0.5 wt % (based on solids) of active dichlorobenzoyl peroxide at a final solids content of 35%. The container with the mixture was put on a jar roller overnight to provide a silicone polymer.

Various blends of (i) a non-halogenated polyisobutylene composition (CE-7) and (ii) a silicone polymer (CE-8) were combined to provide Examples 17 to 19 (see Table 10). The Examples and Comparative Examples were notch bar coated onto the treated side of a 50 micron (0.002 inch) thick MITSUBISHI PET film and dried. The coating gap was set to provide an adhesive having a thickness of 0.051 mm (0.002 inches) after drying in a forced air oven at 150° C. (302° F.) for 5 minutes. The adhesive of the resulting PET-backed tape was then laminated to the LOPAREX release film using two passes of a 2 kg rubber roller to give a tape article.

Next, after removing the protective release liner, a first sample of each tape article was exposed to UV irradiation using an ultraviolet curing lamp (Model #14998, available from UVEXS Corp. Sunnyvale, Calif.) at 11.0 meters per minute (36 feet/min.) to provide a dose of 100 mJ/cm² at a wavelength range of 320 to 390 nm. A light meter (UV POWER PUCK, Serial 2405, available from EIT, Sterling, Va.) was used to calibrate the radiation dose. A second sample of each tape article was UV irradiated in a similar manner with the following changes: a dose of 200 mJ/cm² and a line speed of 7.3 meters per minute (24 feet/min.) were employed. The resulting tape articles were covered again with the LOPAREX release film and stored in a controlled environment room until tested.

The samples were tested according to the 90° Angle Peel Adhesion Strength Test using the EPDM substrate and the Static Shear Strength Test at 23° C./50% Relative Humidity Test (stainless steel). The samples were also tested using the silicone rubber (S-R) substrate according to the 90° Angle Peel Adhesion Strength Test except that the samples were allowed to dwell for 72 hours, rather than 24 hours before testing. The results are summarized in Table 10.

TABLE 10
Test results for Comparative Examples 7 and 8, and Examples 17 to 19.

| | | | UV dose | | | | |
|---|---|---|---|---|---|---|---|
| | | | none | none | none | 100 mJ/cm² | 200 mJ/cm² |
| | | | Peel | Peel | Shear | Shear | Shear |
| | Blend Ratio | | Strength | Strength | Strength | Strength | Strength |
| | CE-7 | CE-8 | EPDM | S-R | St. Steel | St. Steel | St. Steel |
| Ex. | PIB* | Silicone | (N/dm) | (N/dm) | (min.) | (min.) | (min.) |
| CE-7 | 100 | 0 | 41 | 7 | 93 | 291 | 1073 |
| EX-17 | 75 | 25 | 24 | 43 | 406 | 636 | 697 |
| EX-18 | 50 | 50 | 21 | 41 | 2264 | 1846 | 3689 |
| EX-19 | 25 | 75 | 16 | 63 | 10000+ | 5838 | 7330 |
| CE-8 | 0 | 100 | 11 | 51 | 10000+ | 10000+ | 10000+ |

*PIB = the polyisobutylene material of CE-7

### Comparative Examples CE-9 to CE-11

Three commercially available tapes were evaluated for peel adhesion strength according to the 90° Angle Peel Adhesion Strength Test, with the following modifications. For 3M 6035PC (Comparative Example CE-9), the transfer tape sample was first laminated to an aluminum foil having a thickness of 0.08 mm (0.003 inches) by rolling down the adhesive face of the transfer tape to the foil with a 2.0 kg (4.5 lb.) rubber roller using 4 passes, after which the liner was removed and the resulting adhesive/foil article was evaluated for peel strength. For ADCHEM 5000M (Comparative Example CE-10) and ADCHEM 5944M (Comparative Example CE-11), the exposed adhesive was laminated to an aluminum foil in the same manner as described above, after which the liner was removed and the resulting adhesive/foil article was evaluated for peel strength.

The commercial tape samples were tested with both the EPDM and SANTOPRENE substrates. One set of samples was tested after a 24-hour dwell at 23° C. A second set of samples was tested after a 7-day dwell at 70° C. The results were compared to results obtained for Examples EX-3, EX-12, EX-13, and EX-14. The results are shown in Table 11.

TABLE 11
Peel adhesion for commercially available tapes and Examples 3, 12, 13, and 14.

| | Dwell: 24 hours at 23° C. | | Dwell: 7 days at 70° C. | |
|---|---|---|---|---|
| | Peel Strength | Peel Strength | Peel Strength | Peel Strength |
| | EPDM | SANTOPRENE | EPDM | SANTOPRENE |
| Example | (N/dm) | (N/dm) | (N/dm) | (N/dm) |
| CE-9 | 15 | 28 | 4 | 70 |
| CE-10 | 11 | 20 | 2 | 20 |
| CE-11 | 33 | 7 | 44 | 44 |
| EX-3 | 39 | 56 | 97 | 57 |
| EX-12 | 68 | 101 | 191 | 90 |
| EX-13 | 49 | 92 | 242 | 78 |
| EX-14 | 58 | 87 | 221 | 70 |

### Comparative Examples 12 and 13

Samples were prepared by combining a styrene/isoprene block copolymer (KD1340) with a low molecular weight polyisobutylene (G1000). It is believed that the low molecular weight polyisobutylene is compatible with the styrene/isoprene block copolymer and will act a plasticizer in the resulting one phase system. The samples also included a tackifier (ES1310). The compositions of Comparative Examples 12 and 13 are summarized in Table 12. Samples were prepared according to the Solvent Coating Procedure. The samples were tested according to the 90° Angle Peel Adhesion Strength (EPDM and SANTOPREN) and the Static Shear Strength at 23° C./50% Relative Humidity Test (stainless steel). The results are summarized in Table 13.

TABLE 12
Compositions of Comparative Examples 12 and 13.

| | | Weight percent | | | |
|---|---|---|---|---|---|
| | Polymer | Polymer | | | |
| Example | Additive | Additive | G1000 | ES1310 | I-1076 |
| CE-12 | KD1340 | 34.8 | 10.0 | 54.7 | 0.5 |
| CE-13 | KD1340 | 31.4 | 10.5 | 57.6 | 0.5 |

TABLE 13
Shear and peel strength for Comparative Examples 11 and 12.

| | Shear Strength | Peel Strength | Peel Strength |
|---|---|---|---|
| | stainless steel | EPDM | SANTOPRENE |
| Example | (min.) | (N/dm) | (N/dm) |
| CE-12 | 10000+ | 39 | 24 |
| CE-13 | 10000+ | 40 | 15 |

Generally, the pressure sensitive adhesive of the present disclosure comprises two phases, i.e., the polyisobutylene phase and the thermoplastic elastomer phase. In some embodiments, the two phases are co-continuous. In some embodiments, the polyisobutylene phase is continuous and the thermoplastic elastomer phase comprises discrete phases dispersed in the continuous polyisobutylene phase.

Samples of Comparative Example CE-6, and Examples EX-15, -15A, and -16 were analyzed using transmission electron microscopy (TEM) to determine the phase separation behavior of the various samples. Samples were cryo-ultramicrotomed at −55 to −75° C. at a cutting speed of 0.1 mm/s with a target thickness of 100 nm. The sections were brought to room temperature and dried under helium gas and then stained for 30 minutes with 0s04 vapor. Images were collected at 5,000× magnification with a JEOL 200CX transmission electron microscope using bright-field imaging.

Referring to FIG. 2, the TEM of Comparative Example CE-6 shows only the polyisobutylene material, i.e., the light region and some isolated black regions. The black regions are residual talc that had been added to the polyisobutylene material during compounding to aid in breaking the material into smaller crumbs to assist in blending it with the other components of the pressure sensitive adhesives. This talc was also present in Examples EX-15 and EX-16.

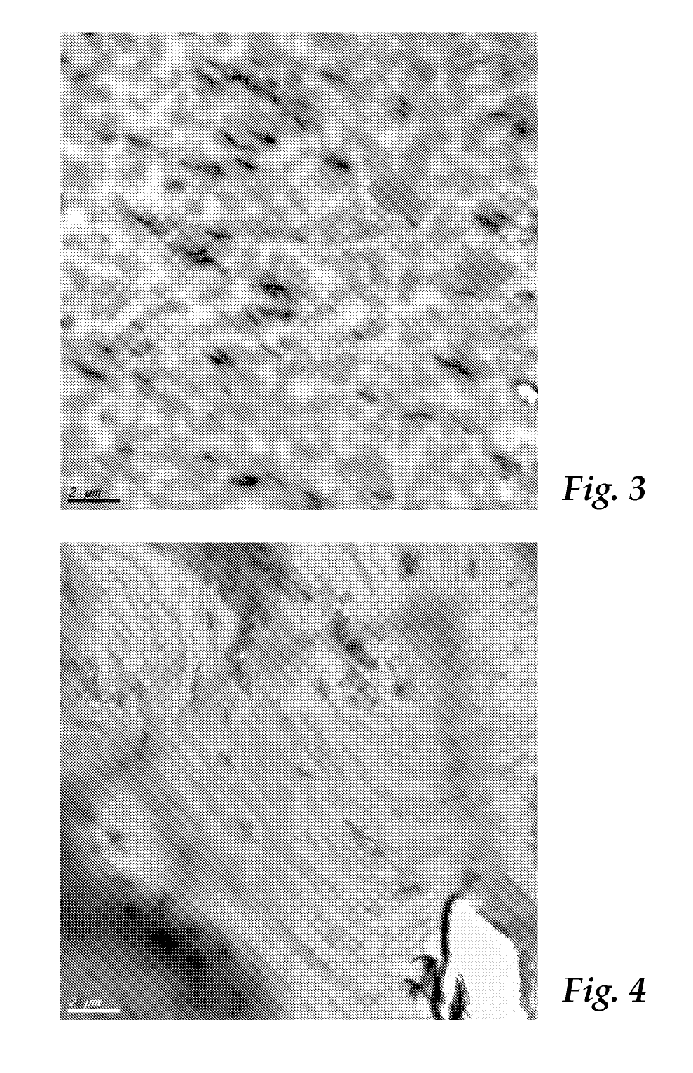

Referring to FIG. 3, the TEM of Example 15 shows the light continuous polyisobutylene phase and the darker, co-continuous, thermoplastic elastomer phase corresponding to the INFUSE polyolefin block copolymer. Again, the isolated black regions correspond to the talc. Similarly, FIG. 4 is a TEM of e-beam cured Example 15A. Again, the image shows the light continuous polyisobutylene phase and the darker, co-continuous, thermoplastic elastomer phase corresponding to the INFUSE polyolefin block copolymer.

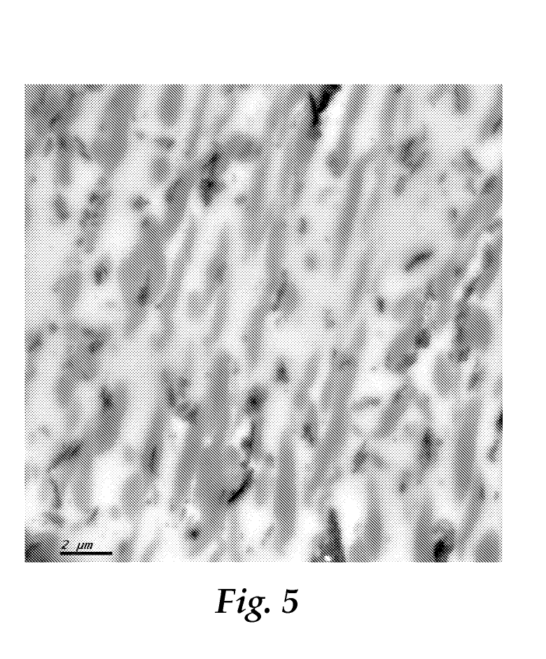

Referring to FIG. 5, the TEM of Example EX-16 shows the light continuous polyisobutylene phase. This TEM also shows the darker discrete thermoplastic elastomer phases dispersed in the continuous polyisobutylene phase. The discrete dispersed phase corresponds to the ENGAGE olefinic copolymer. Again, the isolated black regions correspond to the talc.

1. A pressure sensitive adhesive comprising a first phase comprising a non-halogenated polyisobutylene material, and a second phase comprising a thermoplastic elastomer.

2. The pressure sensitive adhesive of claim 1, wherein the non-halogenated polyisobutylene material has a weight average molecular weight of greater than 100,000 gm/mole.

3. The pressure sensitive adhesive according to claim 1, wherein the thermoplastic elastomer comprises an olefinic polymer.

4. The pressure sensitive adhesive according claim 3, wherein the olefinic polymer is non-polar.

5. The pressure sensitive adhesive according claim 3, wherein the olefinic polymer comprises an olefinic block copolymer.

6. The pressure sensitive adhesive according to claim 1, wherein the thermoplastic elastomer comprises a styrenic block copolymer.

7. The pressure sensitive adhesive according to claim 1, wherein the thermoplastic elastomer comprises an acrylic polymer.

8. The pressure sensitive adhesive according to claim 1, wherein the thermoplastic elastomer comprises a silicone polymer.

9. The pressure sensitive adhesive according to claim 1, wherein the non-halogenated polyisobutylene comprises a copolymer of polyisobutylene and isoprene.

10. The pressure sensitive adhesive according to claim 1, wherein the non-halogenated polyisobutylene comprises a homopolymer of polyisobutylene.

11. The pressure sensitive adhesive according to claim 1, wherein the first phase comprises a blend of a first non-halogenated polyisobutylene material having a weight average molecular weight of greater than 100,000 grams per mole, and a second non-halogenated polyisobutylene material having a weight average molecular weight of at least 10,000 grams per mole and no greater than 100,000 grams per mole, wherein the ratio of the weight average molecular weight of the first non-halogenated polyisobutylene material to the weight average molecular weight of the second non-halogenated polyisobutylene material is at least 2:1, and the ratio of the weight percent of the first non-halogenated polyisobutylene material to the weight percent of the second non-halogenated polyisobutylene material in the pressure sensitive adhesive is at least 1:1.

12. The pressure sensitive adhesive of claim 11, wherein the ratio of the weight average molecular weight of the first non-halogenated polyisobutylene material to the weight average molecular weight of the second non-halogenated polyisobutylene material is at least 4:1, and wherein and the ratio of the weight percent of the first non-halogenated polyisobutylene material to the weight percent of the second non-halogenated polyisobutylene material in the pressure sensitive adhesive is at least 1.5:1.

13. The pressure sensitive adhesive of claim 11, wherein the first phase comprises a blend of a first non-halogenated polyisobutylene material having a weight average molecular weight of greater than 300,000 grams per mole, and a second non-halogenated polyisobutylene material having a weight average molecular weight of at least 30,000 grams per mole and no greater than 100,000 grams per mole, wherein the ratio of the weight average molecular weight of the first non-halogenated polyisobutylene material to the weight average molecular weight of the second non-halogenated polyisobutylene material is at least 2:1, and the ratio of the weight percent of the first non-halogenated polyisobutylene material to the weight percent of the second non-halogenated polyisobutylene material in the pressure sensitive adhesive is at least 2:1.

14. The pressure sensitive adhesive according to claim 11, further comprising a third non-halogenated polyisobutylene material.

15. The pressure sensitive adhesive according to claim 11, wherein at least one of the first non-halogenated polyisobutylene material and the second non-halogenated polyisobutylene materials is a copolymer of isobutylene and isoprene.

16. The pressure sensitive adhesive according to claim 1, wherein at least one of the first non-halogenated polyisobutylene material and the second non-halogenated polyisobutylene materials is a homopolymer of isobutylene.

17. The pressure sensitive adhesive according to claim 1, wherein the first phase further comprises a multi-functional acrylate crosslinker.

18. The pressure sensitive adhesive according to claim 1, wherein the first phase and the second phase are co-continuous.

19. The pressure sensitive adhesive according to claim 1, wherein the first phase is continuous and the second phase is dispersed in the first phase.

20. The pressure sensitive adhesive according to claim 1, wherein the adhesive is crosslinked.

21. The pressure sensitive adhesive according claim 20, wherein the adhesive is crosslinked with actinic radiation.

22. An adhesive article comprising a substrate and a first pressure sensitive adhesive according to claim 1 bonded to a first major surface of the substrate.

23. The adhesive article of claim 22, further comprising a second pressure sensitive adhesive according to claim 1 bonded to an opposite second major surface of the substrate.

24. The adhesive article of claim 22, wherein the substrate comprises at least one of a polymer film and a metal foil.

25. The adhesive article according to claim 22, wherein the substrate comprises a foam.
